(19) United States
(12) Patent Application Publication
(10) Pub. No.: US 2007/0269341 A1
(43) Pub. Date: Nov. 22, 2007

(54) SAMPLING ASSEMBLY AND METHOD OF PREPARING SAMPLES

(75) Inventors: Kurt J. Halverson, Lake Elmo, MN (US); Stephen C. P. Joseph, Woodbury, MN (US); Matthew T. Scholz, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/419,539

(22) Filed: May 22, 2006

(51) Int. Cl. G01N 21/00

(52) U.S. Cl. 422/58

(57) ABSTRACT

Sample preparation system for microbiological and/or other analyte testing is described. A method of preparing samples containing particulates for microbiological and/or other analyte analysis is described. Microorganisms and/or other analytes are suspended as a filtered liquid composition in a specialized sampling assembly that allows mixing, filtering and storing in the same assembly.

### FIELD OF THE INVENTION

The present invention relates to a sample preparation system for microbiological and/or other analyte testing.

### BACKGROUND OF THE INVENTION

The analysis of samples for microorganisms and/or other analytes, such as bacteria, pathogens and toxins is important for public health. Foods grown, purchased and consumed by the general population may contain or acquire microorganisms and/or analytes, which flourish or grow as a function of the environment in which they are located. This growth may lead to accelerate spoilage of the food product or the proliferation of pathogenic organisms, which may produce toxins or allergens. Intrinsic factors affecting the growth of bacteria include pH, moisture content, oxidation-reduction potential, antimicrobial compounds, and biological structures or barriers.

Perishable items with a shelf life are of particular importance for qualitative or quantitative monitoring of microorganisms and/or analytes. In samples, a convenient and efficient means to remove microorganisms and/or analytes from samples for analysis is important in determining product shelf life and safety for human and animal consumption. Sample preparation requires that the microorganisms and/or analytes be suspended or dispersed in a liquid preferably with minimal debris content. Further, representative removal of microorganisms and/or analytes from test samples internally, and on the surface is important for consistent reporting.

The removal of microorganisms and/or analytes from samples may be accomplished with different methods. The removal of microorganisms and/or analytes often requires combining diluents with the sample and mixing the components. Methods include manual shaking, blending, kneading, mechanical shaking, agitation, vortex stirring, ultrasound, mechanical beating, and others to disperse or suspend microorganisms and/or analytes. For determining shelf life, quantification of bacteria is frequently performed by addition of an aliquot of the sample diluents to the surface of a non-selective or semi-selective growth media such as an agar Petri dish. Some of the microorganisms and/or analytes investigated have included the determination of the presence or absence of specific pathogens, including Escherichia coli O157:H7, Pseudomonas aeruginosa, Salmonella, Listeria monocytogenes, Clostridium botulinun, Staphylococcus aureus, Campylobacter jejuni, Yersinia enterocolitica, Vibrio vulnificus, and Enterobacter sakazakii.

Systems designed to release microorganisms and/or analytes from food samples have been previously described. A blender to homogenize samples at 10,000 to 12,000 rpm has been recommended by the Food and Drug Administration, “Food Sampling and Preparation of Sample Homogenate”, Chapter 1; FDA Bacteriological Manual, 8^{th} Ed.; 1998, section 1.06. U.S. Pat. No. 3,819,158 (Sharpe et al.) describes a “stomaching” device, which mixes the sample and diluents in a bag through the use of two paddles in a kneading-type action. An oscillating device known as the “Pulsifier” is described in U.S. Pat. No. 6,273,600 (Sharpe), which utilizes a bag placed inside a metal ring. Another technique, vortexing of samples for microorganism and/or analyte suspension, has been described in U.S. Pat. No. 6,273,600 (Sharpe).

Techniques used to release microorganisms and/or analytes from food and/or nonfood samples may present inconsistent and sometimes undesirable results. An additional limitation is that the described systems provide a means for preparing and subsequent testing of single samples. The blender system homogenizes the sample, but creates a large amount of particulate debris, wherein the container needs to be cleaned and sterilized prior to subsequent use. The stomaching device and pulsifier systems utilize plastic bags, which are disposable, but difficult to handle. The bags are flexible, and therefore, not freestanding when removed from the mixing devices. Removal of samples of diluent from the bottom of the bags is often difficult due to possible contamination of a pipette in contact with the sides of the bag. Additionally, samples containing hard objects may pierce the bag and create leaks and sample contamination. Furthermore, many of these systems require extensive cleaning and sterilization between samples, which is tedious and costly.

### SUMMARY OF THE INVENTION

The invention is directed to a method of preparing samples for microbiological, chemical, and/or analyte testing, using a sampling assembly, which comprises a freestanding container, a first connected filter component, an optional liner, and a lid component. A quantity of a sample comprising at least in part a solid component is added to a sampling assembly with a diluent. The sample and diluent in the freestanding container are agitated for a period of time to suspend microorganisms and/or other analytes in the diluent to produce a liquid composition comprising the diluent, analytes, and sample. A quantity of the liquid composition is filtered to remove particulates, and debris to produce a filtered liquid composition. The liquid composition is further analyzed for microorganisms and/or other analytes.

The method of this invention is particularly suited for any sample containing particulates, wherein a desired analyte such as bacteria, viruses, spores, pathogens, proteins, and the like, are dissolved, dispersed, or suspended in a diluent, filtered to remove the particulates, and the filtered liquid composition is analyzed. The method is particularly suited for food and/or nonfood samples where the samples and diluent may be added to the sampling assembly, agitated, filtered to remove the particulates, such as food and/or nonfood debris, and then analyzed for the presence of microorganisms and/or other analytes.

In another aspect, the invention provides a method using a sample preparation system for microbiological and/or other analyte testing using a sampling assembly comprising a lid component, a first connected filter component, a freestanding container, an optional liner, an optional second connected filter component, an optional filter element, and an optional collar for securing the lid to the container. The first connected filter component may be connected in the lid component, connected in the sidewall of the freestanding container, or connected in the bottom end of the freestanding container. Optionally, the sampling assembly may comprise more than one filter component. Each of the filter components may be permanently connected to the sampling assembly, or may be removably connected.

This invention further provides for microorganisms and/or other analytes present in samples, such as food and/or nonfood samples, to be suspended, dissolved, or dispersed in a diluent comprising a liquid composition within a sampling assembly. The method provides for the efficient preparation of single or multiple samples via agitation, reduction of potential contamination, sample loss, and the extraction or removal of solutions, suspensions or supernatant liquids through a first connected filter component in a disposable container.

The method of this invention further provides for microorganisms and/or other analytes present in samples to be suspended, dissolved, or dispersed in a nutrient formulation comprising a liquid composition within a sampling assembly. The liquid composition may further comprise a selective or semi-selective nutrient formulation in addition to the sample containing particulates. The selective or non-selective nutrient formulation added to the sampling assembly may be sufficient for the incubation of analytes and/or other microorganism for a period of time. The incubated liquid composition may further be filtered through a first connected filter component, and subsequently analyzed.

Optionally, the freestanding container may contain a liner disposed within the freestanding container, which may be deformable and/or disposable. The freestanding liner and other components of the sampling assembly may be supplied sterile, or may be fabricated from a material that is compatible with common sterilization and disinfection procedures such as steam, gamma radiation, ethylene oxide, hydrogen peroxide, peracetic acid, and hydro-alcoholic solutions.

The method for preparing a sample for microbiological and/or other analyte testing of the present invention provides flexibility to a user with regard to the use of a first connected filter component. The first connected filter component may comprise an extensive selection of optionally different pore sizes, which are selected to remove particulates. The first connected filter component in conjunction with a second connected filter component provide a series of filter components for different applications, and for the removal of successively smaller particulates from the sample. Multiple connected filter components in succession are considered.

In a further exemplary embodiment, the present invention is directed to a sampling assembly comprising (a) a lid component comprising (i) a first end suitable for connecting to a freestanding container capable of containing one or more samples, such as food and/or nonfood samples, in a diluent; a second end opposite the first end; an inner surface and an outer surface both of which extend from the first end to the second end; and an opening extending through a portion of the lid component from the first end to the second end; and (ii) a first connected filter component attached to the inner surface of the lid component or optionally the free-standing container; (b) a reusable or disposable freestanding container having (i) at least one container side wall, (ii) a container bottom end, (iii) a container top end having a container opening therein, and (iv) a set of optional threads extending along the at least one container side wall; (c) an optional deformable liner, wherein the liner has (i) at least one liner side wall, (ii) a liner bottom end, (iii) a liner top end having a liner opening therein, and (iv) a liner rim extending along and protruding from the liner top end, wherein the liner is capable of containing one or more samples and diluents; and (d) an optional collar, wherein the collar has (i) a top end having a collar opening therein, (ii) a bottom end, (iii) at least one collar side wall extending between the top end and the bottom end, (iv) a collar rim extending along the top end and protruding into the collar opening, and (v) a set of optional threads extending along the at least one collar side wall, wherein the set of threads is capable of engaging with the set of threads on the freestanding container; wherein the lid component, the freestanding container, the optionally deformable liner and the optional collar are capable of being configured and combined with one another to form a sampling assembly.

In a further exemplary embodiment, the present invention is directed to a sampling assembly of the method comprising multiple filter components. The first connected filter component may be connected to the lid component. As earlier described, a first connected filter component may be used in collaboration with a second connected filter component or additional filter components. The filter components may be located in the lid, or optionally in a freestanding container, or in combination with each other. One or more of the filter components may be connected, removably connected, or permanently connected to the lid component or freestanding container. Additionally, a series of filter components may be used in the sampling assembly for recovering a filtered liquid composition of suspended microorganisms and/or other analytes from a food or soil sample for testing. The filters may be arranged where a coarse filter, i.e. first connected filter component, acts as a pre-filter with a larger pore size relative to subsequent filters, i.e. second connected filter component, third connected filter component, etc., with smaller pore sizes for the collection of a filtered liquid composition. The filter components or elements may be arranged for use with the sampling assembly in an upright position, whereas the filters may be arranged for an assembly where the assembly is inverted. An example of multiple filters may be found in a nested filter design system. The first connected filter components or filter element may be collapsible or rigid with an original structure supporting the filter element.

Mixing by agitation of multiple samples provides for effective and efficient microorganism and/or analytes removal. Also, sampling assemblies comprising reusable freestanding containers, and optional freestanding disposable liners provide for enhanced handling during weighing, diluent addition, and sample removal. Further, the sampling assemblies provide a means for easier transport of liquid compositions, and extraction of microorganism and/or analytes from liquid compositions over current plastic bags of the stomaching device and pulsifier. The benefit of reduced contamination of the samples in these assemblies is provided. During mixing, the sample is sealed and contained in the assembly. Sampling of the suspended microorganism and/or analyte solutions can be achieved through a first connected filter component in the freestanding container, or optionally through a sampling port of the lid or container. Lastly, a disposable sampling assembly provides for no cleaning, no additional handling, nor sterilization of components. Such freestanding disposable liners may be provided sterile or optionally contain a predetermined amount of diluent or nutrient growth solution for additional convenience and to ensure a contamination-free container.

### BRIEF DESCRIPTION OF THE DRAWINGS

FIG. 1 is an exploded perspective view of a sampling assembly used in the sample preparation system for microbiological and/or other analyte testing according to the present invention.

FIG. 2 is an enlarged cross-sectional view of the exemplary lid component of FIG. 1 with a first connected filter component attached thereto.

FIG. 3 is an enlarged view of a sampling assembly wherein the sample is retained within a first connected filter component of the freestanding container or optionally in the lid component.

FIG. 4 is a bottom view of a lid of the sampling assembly, wherein the filter element is connected to the lid component; and

FIG. 5 is an enlarged cross-sectional view of the exemplary lid of FIG. 4 as viewed along section line 3-3 with the filter element.

### DETAILED DESCRIPTION OF THE INVENTION

### Definitions:

A “food” as used herein, is a solid, liquid, or semi-solid composition intended for human or animal consumption. Non-limiting examples include various meats, fish and seafood, vegetables, fruits, prepared foods such as soups, sauces, pastes, cereals, breads, canned foods, cheese, milk, and other dairy products, fats and oils, desserts, condiments and spices, pastas, beverages, water, and the like.

A “diluent” is used as a substance to dilute a sample. The diluent is combined with a sample in any order to form a liquid composition comprising the sample, diluent, particulates, and any analyte (such as bacteria, toxins, and DNA), and may be a dispersion, emulsion, solution, or combination thereof. A diluent of this invention may be a sterile liquid, optionally containing surfactants and other components, which aids in suspending microorganisms and/or analytes from a sample for subsequent microbiological and/or other analyte testing, such as the identification and quantification of bacteria or toxins. The diluent may optionally contain bacterial nutrient ingredients or agents for selective growth of specific organisms. It may also contain components to neutralize preservatives and other antimicrobial agents that may be present in the food or nonfood samples. The diluent may also contain buffering agents for maintaining a desired pH. In general, the diluent of this invention is sterile water with other components, but it may also comprise one or more organic solvents to selectively dissolve, suspend, or disperse other analytes, such as toxins in samples. Aqueous organic solvents are also contemplated.

A “first connected filter component” used in this invention comprises a filter element or multiple filter elements, such as a second connected filter component, connected or affixed to the lid component, sidewall of the freestanding container, or the bottom of the freestanding container of a sampling assembly. The first connected filter component retains or separates the particles and/or debris, and allows the analytes of the liquid composition to pass through the filter. The first connected filter component may also function as a sampling port in a lid component or container. The component may additionally function as an opening while decanting or inverting a liquid composition of suspended microorganisms and/or analytes for analysis, or particulate removal. The first connected filter component may further be used as a retainer/holder for a sample.

The term “deformable” used in this invention relates to an optional liner of the sampling assembly. The liner may be disposed within the freestanding container. A deformable liner is altered from its original shape or state by pressure or stress. The liner described herein has dimensions, which may be changed during the removal of a liquid composition. The freestanding container may have an optional opening either in the sidewall of the container, or the bottom end of the container, which facilitates access to the deformable liner. Pressure may be applied to the liner to reduce its size from the original dimensions, and promote the removal of a liquid composition through a first connected filter component or a sampling port.

The term “liquid composition” used in this invention refers to the sample which may contain particulates, diluent, and analytes added to the sampling assembly. The sample, either food or nonfood, may contain a particulates and analytes, which are located within or on the surface of the sample. The particulates and debris of the liquid composition are filtered and retained separately from the analytes in the diluent. The analytes, i.e. microorganisms, are suspended, dissolved, or dispersed within the diluent during agitation. Analyte testing of the liquid composition (filtered) may be commenced to determine the presence or absence of the analyte of interest in the sample.

The term “filtered liquid composition” used in this invention refers to the liquid composition described above that has been filtered through a first connected filter component and/or subsequent connected filter components to remove the particulates and debris, and further comprises the analytes, or lack of analytes in a diluent.

The term “particulate” and or “particulates” used in this invention refers to anything insoluble retained by the filter component. The particulate and/or particulates may be the sample itself. The particulate and/or particulates may be the sample residue and/or sample debris resulting from the agitation process.

The term “analyte” used in this invention refers to the substance or chemical constituent within a sample, which is analyzed by methods such as titration, thermal analysis, spectroscopy, UV, not limited only to the techniques presented. The food or nonfood samples, containing particulates, may have analytes within the sample or on the outer surface of the samples. The liquid composition containing the analyte and/or analytes, is filtered and then recovered. The analytes of the filtered liquid composition may be further analyzed for, but are not limited to bacteria, viruses, spores, pathogens, proteins, yeasts, and others.

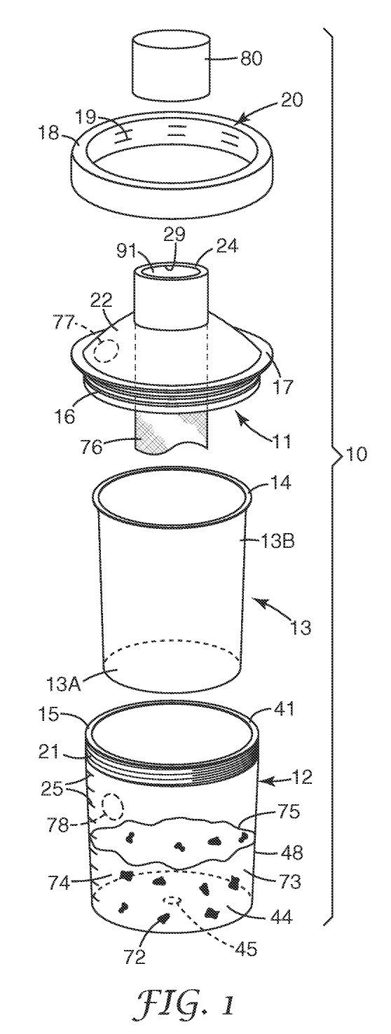

A method of using a sampling system of FIG. 1, comprising a sampling assembly 10 for the preparation of samples 72, such as food or soil, for microbiological analysis and/or other analytes is disclosed. The sampling assembly 10, while suitable for use in containing samples 72 in diluents 74, can be optionally used as a plurality or array of sampling assemblies 10 to contain multiple liquid compositions 73 for expedited and efficient sample testing for microorganisms and/or analytes. Analogous reference of assembly 10 can be found in International Publication No. WO 98/32539, U.S. Pat. No. 6,536,687, and U.S. Pat. No. 6,588,681, the subject matter of all of which is incorporated herein in its entirety by reference.

An exemplary sampling assembly 10 of FIG. 1 comprises a lid component 11, a freestanding container 12, an optional liner 13, and an optional collar 20 for securing the lid component 11 to the freestanding container 12. In this embodiment, liner 13 is disposed within freestanding container 12. The lid component 11 further comprises a first connected filter component 76, wherein the sample 72 and diluent 74 comprise a liquid composition 73 after agitation in the sampling assembly 10.

In another embodiment, the first connected filter component 100 may be located in the freestanding container 12 sidewall 48, without the optional liner 13. First connect filter component 100 may be permanently attached or removably attached to container 12 as shown with container sampling port 102 in FIG. 3.

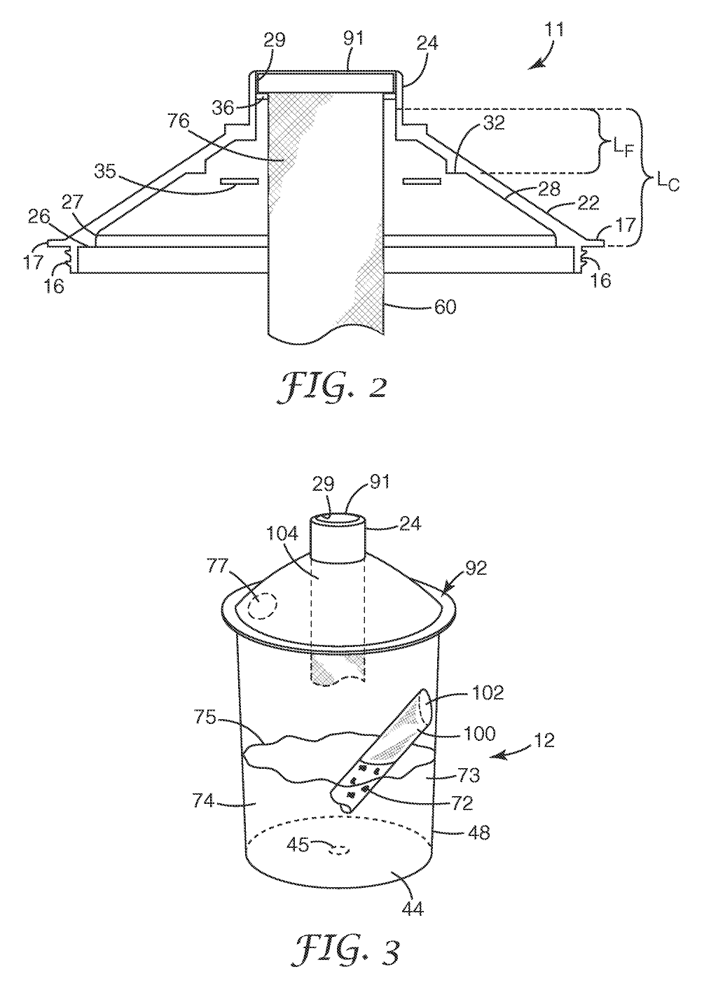

Further, in FIG. 1 and FIG. 3, first connected filter component 76 and 104, respectively, are shown at the central axis of lid component 11 and 92, respectively, and may be optionally located at other “off-axis” positions on the lid component 11 and 92. Lid sampling port 77 is representative of a location for first connected filter component 76 and 104, respectively, in an “off-axis” position. The filter pore sizes of the first attached filter component 76 and 104, respectively, may be of at least 5 micrometers, preferably at least 40 micrometers, more preferably at least 80 micrometers, and most preferably at least 120 micrometers. The mesh pore size opening may be of at most 2000 micrometers, preferably at most 1000 micrometers, more preferably at most 500 micrometers, and at most preferably 200 micrometers. First connected filter component 76 and 104, respectively, have pore sizes sufficient for retaining particles from the liquid composition 73, but allowing the analytes contained within the liquid composition 73 to pass through the first connected filter component 76 and 104, respectively, for extraction and/or sampling. Further, the first connected filter component 76 and 104, respectively, may be optionally collapsible, wherein the filter folds under its own weight, or rigid, wherein the optionally collapsible filter is in a rigid cylindrical frame portion 60 as shown in FIG. 2. The first connected filter component 76 and 104, respectively, may be of any geometrical shape to sufficiently filter material. The size and number of the filter components, and porosity thereof, may be varied depending on the desired analyte and particulate contaminate in a sample. In some instances, the sample may comprise a food sample, where the desired analyte is bacteria, and the particulates are food particles or debris. The filter components are selected to retain or separate the food particulates, while allowing the bacteria to pass through the filter for subsequent analysis. In another instance, the sample may compromise a lysed bacterial cell culture where the particulate contaminate is cellular debris and the desired analyte is DNA, RNA, a protein, or metabolic product, or other metabolite. The filter component is further selected to retain and/or separate the cellular debris, while allowing the desired metabolite to pass for subsequent analysis.

In another embodiment, lid component 11 may be permanently attached to container 12 during the manufacturing of a one-piece sampling assembly 10.

Further, lid component 11 may be formed to have any desired shape. Suitable shapes include, but are not limited to, a conical shape, a cylindrical shape, a tubular shape having a rectangular cross-sectional area, or a tubular shape having a square cross-sectional area. In one desired embodiment, as shown in FIGS. 1 and 3, lid component 11 and lid component 92, respectively, have a conical shape with a first end and a second end opposite the first end.

A sample 72 which may contain particulates, analytes, and a diluent 74, which are added to the interior volume of freestanding container 12, or to an optional liner 13, after agitation comprise a liquid composition 73 as depicted in FIG. 1. The liquid composition 73, wherein the sample 72 contains a particulates and analytes, and an optional diluent 74, are further dissolved, dispersed or suspended therein. The sample 72 may comprise any sample having particulates that may be removed by the first connected filter component 76 to provide a filtered liquid composition 73 containing the desired analyte and/or microorganisms in a diluent. The sample 72 may comprise food samples such as meat, beverages, poultry, fish, eggs, fruits, vegetables, dairy products, prepared food products, and grain products. The sample 72 may be solid, liquid or a combination thereof The sample 72 may be added to the freestanding container 12 first, and then followed by the diluent 74, or the diluent 74 may be added first to the freestanding container 12 followed by the sample 72. Alternatively, the sample 72 and diluent 74 may be combined prior to addition to the freestanding container 12.

In a further embodiment, a sample 72, such as a food or soil sample, and a diluent 74 are added to the interior volume of freestanding container 12, or to optional liner 13. Analogous to the sample 72 described above, the nonfood sample 72 contains particulates, and/or analytes for analyte testing, where the analyte is dissolved, dispersed, or suspended within the diluent 74. The nonfood sample 72 may comprise soil, feces, tissue, wood, bodily fluids, plant matter, sediment, animal feed, and other materials not intended for human consumption. The nonfood sample 72 may be solid, liquid, or a combination thereof Similar diluent 74 additions as in sample 72 comprising food samples are described above.

Optionally, freestanding container 12 and/or the liner 13 disposed within freestanding container 12 may contain indicia 25 as depicted in FIG. 1 to indicate the levels to which a diluent 74 and/or sample 72 may be added to container 12 to achieve a desired weight ratio of the liquid composition 73, where the sample 72 to diluent 74 ranges from 1:100 to 1:1. One exemplary indicia suitable for use in the present invention comprises indicia as disclosed in U.S. Pat. No. 6,588,681, the subject matter of which is incorporated herein in its entirety by reference.

The diluent 74 is a sterile buffered solution (Butterfield's Buffer, Edge Biological, Memphis, Tenn.), or a selective or semi-selective nutrient formulation, wherein the selective or non-selective nutrient formulation may be added to the sampling assembly 10 for the incubation of analytes (i.e. growth of bacterial analytes) for a period of time within the sampling assembly 10. In one embodiment, a sterile diluent 74, or selective or non-selective nutrient formulation is sealed in a pre-measured amount in a freestanding container 12, or optional liner 13 with a removably attached cover. Further, a pre-measured amount of a powdered or dry media may be provided in a freestanding container 12 or optional liner 13 with a removably attached cover.

In another embodiment, liner 13 is further disposed into the container 12. When liner 13 is used, liner 13 may be filled prior to or after being positioned within container 12. Preferably, liner 13 is freestanding for purposes of weighing and transport of samples. Further, the liner 13 may be disposable and/or deformable, and collapsible by hand force. Liner 13 may be deliberately deformable, whereby the deformed liner 13 imparts a disruption to the liner's surface geometry. Additionally, the disrupted surface geometry may assist in the breakup of the sample 72 during vortexing, or other agitation means.

When lid component 11 is used and disposed within optional liner 13, optional collar 20 is optionally threaded onto freestanding container 12. The container 12 is closed, and preferably hermetically sealed to a lid component 11. In another embodiment, lid component 11 may be hermetically sealed to liner 13. Closure 80 of FIG. 1 may be used to close, seal, or hermetically seal an opening, wherein closure 80 is selectively removable from lid opening 91, or lid sampling port 77 of the sampling assembly 10.

In a separate embodiment, the interior of the first connected filter component 100 may serve as a retainer/holder of a sample 72 as shown in FIG. 3 connected through the container sampling port 102 of freestanding container 12. Optionally, a first connected filter component 104 may be connected onto the lid component 92 through lid opening 91. In this embodiment, sample 72 is disposed within the volume of the first connected filter component 100, rather than the sample 72 being disposed within the volume of freestanding container 12 or optional liner 13. Further, the diluent 74 is disposed within the volume of the freestanding container 12 or optional liner 13, wherein the first connected filter component 100 is in fluid communication, where the diluent 74 can flow in and out of the volume occupied by the filter 100, with the sample 72 and diluent 74. The liquid composition 73 is located in freestanding container 12, with the sample 72 containing particulates, and debris remaining within the volume of the first connected filter component 100.

The first connected filter component 76 containing the sample 72 is below or partially below the liquid composition level 75 of the diluent 74 while the sample 72 and other particulates and/or debris are retained within the volume of the filter. During agitation of the sample 72 and diluent 74, the analytes and/or microorganisms from the sample 72 are suspended, dissolved or dispersed in the diluent 74. After a sufficient period of time for agitation, the filtered liquid composition 73, which has been filtered of debris and particulates, is extracted from the sampling assembly 10 through the lid sampling port 77, freestanding container sampling port 78, and/or container opening 45, which may optionally contain a closure. Closure 80 seems be fitted for first connected filter component 76.

For example, the first connected filter component 76 may be below, or partially below the liquid composition level 75 of the sampling assembly 10 of FIG. 1. As the components of the liquid composition 73 are agitated, debris, residue, and particulates are excluded from the interior or volume of the first connected filter component 76, and the filtered liquid composition 73 collects inside of the first connected filter component 76. The liquid composition 73 is in fluid communication with the first connected filter component 76. The filtered liquid composition 73 is further extracted from the first connected filter component 76 with the removal of closure 80, wherein the filtered liquid composition 73 contains microorganisms and/or other analytes for future analysis.

The first connected filter component 76 may have varying pore sizes. Filter pore sizes of different substrates and configurations can be determined as described in Lenntech Water Treatment & Air Purification Holding B. V., The Netherlands. The filter pore sizes of the first attached filter component 76 described in this invention may be of at least 5 micrometers, preferably at least 40 micrometers, more preferably at least 80 micrometers, and most preferably at least 120 micrometers. The filter pore size opening may be of at most 2000 micrometers, preferably at most 1000 micrometers, more preferably at most 500 micrometers, and at most preferably 200 micrometers, which is sufficient to retain particles from the sample 72, but allow the analytes contained within the liquid composition 73 to pass through the filter pores. Further, the first connected filter component 76 may be optionally collapsible, wherein the filter folds under its own weight, or rigid, wherein the filter is attached or held within a cylindrical, or other appropriate shape, frame portion 60 of FIG. 2.

The first connected filter component 76 varies in its dimensions. The length, height, width, and/or other dimensional features of the first connected filter component 76 are dependent on the sampling assembly 10 component dimensions, and its respective use for a particular application. The dimensions of first connected filter component 76 of FIG. 2, connected to the inside surface 28 of lid component 11 varies, whether the sample 72 is disposed within the volume of the first connected filter component 76, or the sample is disposed within the freestanding container 12 or optional liner 13. The filter component 76 may extend below or partially below the liquid composition level 75, or be located above, or partially above the liquid composition level 75 as further shown in FIG. 3. FIG. 2 further depicts an embodiment where the first connected filter component 76 may be disposed in a rigid cylindrical frame portion 60 consisting of a polymeric material. The first connected filter component 76 contained within a cylindrical frame portion 60 of this embodiment may be located in opening 91, and optionally located in lid sampling port 77 of lid component 92 of FIG. 3.

In another embodiment, the first connected filter component 76 may be above, or partially above the liquid composition level 75. The first connected filter component 76 may be permanently attached or removably attached to the lid component 11 and/or freestanding container 12 of the sampling assembly 10.

The freestanding container 12, or optionally liner 13 disposed within freestanding container 12 may be further sealed to reduce contamination with a lid component 11. The lid component 11 comprises a first connected filter component 76 within a freestanding container 12 of the sampling assembly 10. The opening 91 of lid component 11 may be closed or hermetically sealed with a closure 80. Additionally, lid sampling port 77 and/or lid opening 91 having a first connected filter component 76 may be closed or hermetically sealed with closure 80. The closure may be attached to the lid component 11 or separate from the lid component 11.

In another embodiment, a closure 80 may be attached to the freestanding container 12 to close or hermetically seal container sampling port 102 and/or container opening 45. As shown in FIG. 3, container sampling port 102 may optionally contain first connected filter component 100.

In a further embodiment, the first connected filter component 100 may be located in freestanding container opening 45.

The liquid composition 73 comprising the sample 72 containing particulates, analytes, and diluent 74 is further agitated by means such as shaking, vortexing, ultrasonics, and the like. The agitation of sample 72 and/or diluent 74 in the sampling assembly 10 may be in a circular orbit, elliptical orbit, or of other means to ensure effective and efficient mixing and suspension, dissolution, or dispersion of microorganisms and/or analytes in the liquid composition 73. The sampling assembly 10 may be secured by clamping or other means to minimize sample spillage and/or loss, wherein the liquid composition 75 within the assembly 10 is closed or preferably hermetically sealed. The liquid composition 73 in the sampling assembly 10 may be agitated by a Burell Model 75 Wrist Action Shaker (Burrell Scientific, Pittsburgh, Pa.), at a frequency of 10 to 2000 cycles/minute, and preferably at a frequency of 200 to 500 cycles/minute, to suspend, dissolve, or disperse the microorganisms and/or other analytes in the liquid composition 73 for a selected duration of time. A liquid composition 73 may be agitated for at least 10 seconds, preferably at least 15 seconds, more preferably at least 30 seconds, and even more preferably at least 40 seconds, and most preferably at least 60 seconds. The liquid composition may be further agitated for at most 15 minutes, preferably at most 10 minutes, more preferably at most 5 minutes, and most preferably at most 3 minutes.

In another embodiment, the liquid composition 73 contained within sampling assembly 10 may be vortexed in a VX-2500 Multi-Tube Vortexer (VWR Scientific Products, West Chester, Pa.) at an agitation frequency of 200 to 5000 revolutions/minute, and preferably 1000 to 3000 revolutions/minute, to suspend, dissolve, or disperse the microorganisms and/or other analytes in the liquid composition 73 for a selected duration of time.

Samples 72 and diluents 74 may be added to container 12 or optional liner 13 of sampling assembly 10. An array or plurality of sampling assemblies 10 comprising liquid compositions 73 may be placed on a plate, an arm or other devices, and secured by gravity, clamping and other means for subsequent agitation. One or more sampling assemblies 10 may be agitated at one time to suspend microorganisms and/or analytes in the liquid compositions 73 comprising samples 72 which may contain particulates, analytes, and diluents 74. Further, agitation of the sampling assemblies 10 may occur via the methods described above. A preferred number of sampling assemblies 10 agitated at one time are about 1 to about 50 sampling assemblies 10, and preferably about 10 to about 25 sampling assemblies 10 on a single agitation device or with multiple agitation devices.

In a further embodiment, the liquid composition 73 is agitated by the addition of a mechanical stirrer with a shaft and stirring blades, which may be inserted through an lid opening 91 if no first connected filter component 76 is present, or optionally, through lid sampling port 77 of lid component 11, or of container 12 of the sampling assembly 10. Agitation of the liquid composition 73 may be further accomplished with steel ball bearings, magnetic stirring bars, blades, and other means to assist in breaking up and/or dispersing the sample 72 in diluent 74 to release the microorganisms and/or other analytes from the outer surfaces as well as within the sample 72 containing particulates and analytes. The agitation of samples 72 in diluent 74 is not limited to the methods described above.

The liquid composition 73 after agitation as described above is filtered through a first connected filter component 76 having filter pore sizes selected to remove particles, debris, or other particulates, but allow for the microorganisms and/or analytes of the liquid composition 73 to pass through. FIG. 2 shows an enlarged view of lid component 11 with first connected filter component 76 used for filtering liquid compositions. The filtered liquid composition 73 is further analyzed for microorganisms and/or other analytes. The first connected filter component 76 has a shape that encloses a volume of the liquid composition 73, wherein the first connected filter component 76 can be used to recover a filtered liquid composition 73, as depicted in FIG. 1 and FIG. 3, acquired by decanting, extraction, inversion, and other known techniques. The sampling assembly 10 may remain upright, tilted, tipped, or inverted to adjust the filtered liquid composition 73 level 75 comprising the sample 72 and diluent 74. During agitation of the sample 72 and diluent 74, which is preferably in fluid communication with the first connected filter component 76, the liquid composition 73 flows through the first connected filter component 76 without removing the lid component 11, where the filtered solution is collected for analysis of microorganism and/or analyte content. The first connected filter component 76 may be located in lid component 11, freestanding container 12, and in other combinations.

Optionally, with liner 13 disposed in freestanding container 12, the liner 13 may be deliberately collapsed via hand gripping force or other means by applying pressure through container opening 45 in the container bottom end 44 of freestanding container 12, or by applying hand gripping force or other means through freestanding container sampling port 78 of freestanding container sidewall 48. This action forces the liquid composition 73 through the first attached filter component 76.

In another embodiment, the first connected filter component 76 may contain a filtered liquid composition 73 sufficient for extraction by pipette, or by other removal means. Where the samples 72 are retained within the volume of the freestanding container 12 or optional liner 13, the filtered liquid compositions 73 may be obtained through lid opening 91 from the volume of the first connected filter component 76 as shown in FIG. 1. In sampling assembly 10, where samples 72 are retained within the volume of the first connected filter component 104, the filtered liquid composition 73 may be obtained through container sampling port 77 of lid component 92 as shown in FIG. 3.

In another embodiment, the first connected filter component 76 is above, or partially above the liquid composition level 75 comprising a sample 72 containing particulates and analytes, and a diluent 74 in a sampling assembly 10, where the liquid composition 73 is in the freestanding container 12, or in optional liner 13 disposed within freestanding container 12. As the components of the liquid composition 73 are agitated, the debris and particulates may collect on the outside of the first connected filter component 76. In this embodiment, the liquid composition 73 is in fluid communication with the first connected filter component 76. The filtered liquid composition 73 may be recovered by pipetting, decanting, inverting, or by other means. With a first connected filter component 76 located in lid opening 91, or lid sampling port 77, the filtered liquid composition 73 may be recovered from within the volume of the first connected filter component 76. In a further embodiment, the first connected filter component 100 may be located in freestanding container 12 in container sampling port 102, or container opening 45 as shown in FIG. 3.

Recovery of the microorganisms and/or other analytes of the filtered liquid composition 73 may provide for aerobic count testing, for example, and by other means, such as growth (plating), genetic techniques such as polymerase chain reaction (PCR), or other techniques known in the art, but can be conveniently done using Petrifilm™ Plates, and quantified using a Petrifilm™ Plate Reader (3M Company, St. Paul, Minn.).

As shown in FIG. 1, the lid component 11 may further comprise several filter components, such as a second connected filter component, located at a different location, or in the same location sufficient for filtering microbiological and/or other analyte samples. For example, as shown in exemplary lid component 11, the lid component 11 may comprise straight edges along the outer surface of cylindrical portion 24 of lid opening 91, wherein lid opening 91 comprises a first connected filter component 76. Optionally, lid component 11 may comprise a lid sampling port 77 containing a first connected filter component 76. Lid component 11 may further comprise multiple filters within lid opening 91 and/or lid sampling port 77. The above-described lid component 11 features used in the sample preparation system comprising a sampling assembly 10 for microbiological testing are further described in U.S. Pat. No. 6,536,687, the subject matter of which is incorporated herein in its entirety by reference.

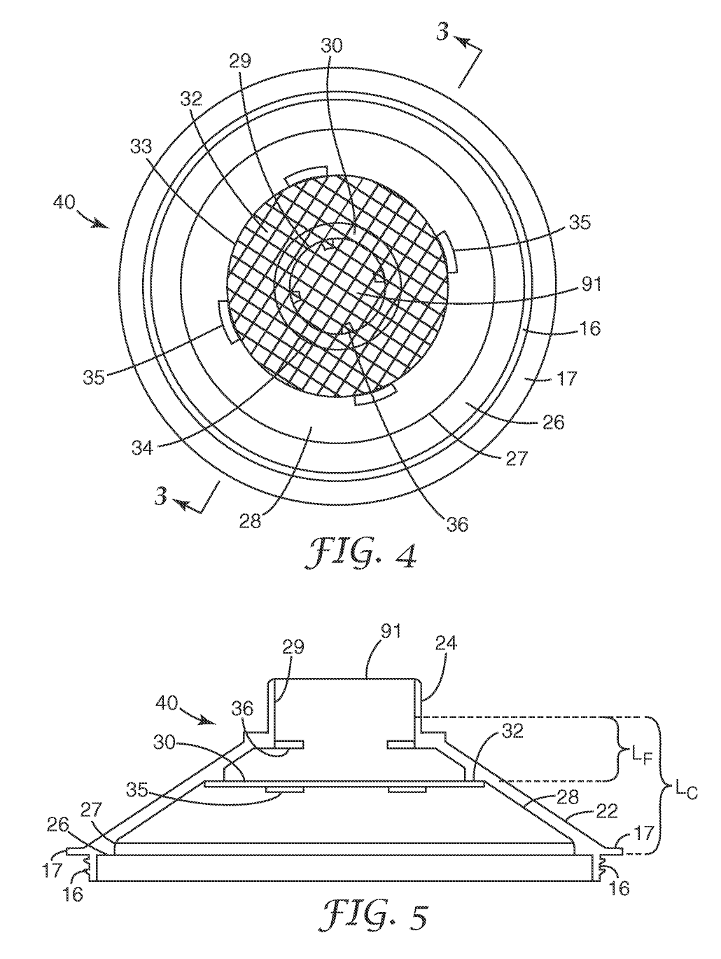

The sampling assemblies 10 of the present invention comprise several components described above to effectively and efficiently recover a filtered liquid composition 73 for the determination of microorganism and/or other analyte content. In another embodiment, the sampling assembly 10 used in the method of this invention further comprises a lid 40 comprising a filter element 30. FIGS. 4 and 5 provide a bottom view and an enlarged cross sectional view, respectively, of exemplary lid 40 shown for use with the sampling assembly 10 of FIG. 1. Lid 40 typically comprises an injection molded part formed from plastic materials such as polypropylene, polycarbonate, acrylics, polystyrene, polyolefin, high density polyethylene, high density polypropylene, and the like. Desirably, lid 40 is transparent to enable viewing of inner surface 28 and other components attached to inner surface 28 of FIGS. 4 and 5. Lid 40 may be removably attached to freestanding container 12 with optional liner 13, or permanently attached to freestanding container 12 with optional liner 13 of the sampling assembly 10.

In one embodiment, lid 40 may be permanently attached to container 12 during the manufacturing of a one-component sampling assembly 10.

Lid 40 may be formed to have any desired shape. Suitable shapes include, but are not limited to, a conical shape, a cylindrical shape, a tubular shape having a rectangular cross-sectional area, or a tubular shape having a square cross-sectional area. In one desired embodiment, as shown in FIGS. 4 and 5, lid 40 has a conical shape with a first end and a second end opposite the first end.

Exemplary lid 40 further comprises filter element 30 of FIGS. 4 and 5. Filter element 30 is connected to lid 40 along upper lid ledge 32, which has a ledge surface area that extends from outer circumference 33 to inner circumference 34. Desirably, an outer periphery of filter element 30 is attached to lid ledge 32 positioned along inner surface 28 of lid 40. In one desired embodiment, upper lid ledge 32 has a surface area that is substantially within a horizontal plane.

Filter element 30 may be connected to lid 40 using a variety of techniques. Suitable techniques for attaching a filter element 30 to a lid 40 include, but are not limited to, ultrasonic welding, any thermal bonding technique (e.g., heat and/or pressure applied to melt a portion of the lid 40, the filter element 30, or both), adhesive bonding, stapling, and stitching. In one desired embodiment of the present invention, the filter element 30 is attached to the lid 40 using an ultrasonic welding process.

As used herein, the phrase “connected” is used to describe the degree of adherence between the filter element 30, and the lid 40. By “connected,” it is meant that the filter element 30 remains intact with the lid 40 until an outside force is applied to physically remove the filter element 30 from the lid 40. Filter element 30 may be removably connected or permanently connected to lid 40.

The degree of bonding between filter element 30 and lid 40 may vary depending on a number of factors including, but not limited to, the filter element 30 materials used, the lid 40 material, the bond surface area, and the type of connection means used. For example, if the filter element 30 has frayed edges, a wider, bonding surface area may be used and/or a knurled ultrasonic weld may be used. A wider, knurled ultrasonic weld captures any frayed edges of the filter element. To minimize the amount of fraying, the filter element 30 may be cut using a laser, which fuses the edges of the filter element 30 material. Since the filter element 30 possesses a minimum amount of fraying, if any, a narrower seam weld or bond area may be used. Desirably, the seam weld or bond area extends completely around an outer periphery of the filter element 30, and has an average seam width (i.e., a dimension within the same plane and substantially perpendicular to the outer periphery) up to 5.0 mm, and more desirably, ranging from 1.0 mm to 3.0 mm. Alternatively, filter element 30 may be an integral element formed by a molding process.

Filter element 30 and lid 40 of FIGS. 4 and 5 may be formed from a variety of materials. Filter element 30 and lid 40 may comprise similar or dissimilar materials. Suitable materials include, but are not limited to, polypropylene, polyethylene, nylon, polyester, polycarbonate, acrylics such as polymethylmethacrylate, fluourinated polymers such as PTFE, cellulosics including modified celluloses such as cellulose acetate, fiberglass, polyurethane, or a combination thereof In one desired embodiment, filter element 30 is formed from a nylon nonwoven or woven fabric, while lid 40 is an injection molded part formed from polypropylene or high density polyethylene. In a preferred embodiment, lid component 40 is sterile, and formed from polypropylene. In this embodiment, the nylon filter element 30 is desirably attached to the polypropylene lid 40 via an ultrasonic welding technique. During ultrasonic welding, an outer surface layer of upper lid ridge 32 melts to mechanically bond filter element 30 to lid 40. Since nylon has a higher melting temperature than polypropylene, the nylon filter element 30 maintains its structural integrity during the ultrasonic welding process. In this exemplary embodiment, a portion of the outer surface layer of upper lid ridge 32 enters into a portion of filter element 30 next to upper lid ridge 32 encapsulating a portion of filter element 30.

Filter element 30 may have dimensions and shapes that vary for a given application. Filter element 30 of lid 40 may have any desired shape including, but not limited to, a circular shape, a square shape, a rectangular shape, a triangular shape, a pentagonal shape, a star shape, etc. In one desired embodiment, filter element 30 has a circular shape.

The dimensions of filter element 30 may vary depending on the lid 40 sizes. In an embodiment, filter element 30 has a largest dimension (i.e., length, width, or diameter) ranging from 15 mm to 100 mm although filter element 30 may have smaller or larger dimensions. For example, in one embodiment, a filter element 30 may have a circular shape and a diameter of 56 mm.

The presently preferred element fabric used to form filter element 30 typically comprises a woven element having any desired element opening size. Alternatively, the filter element 30 may be made as a molded structure or comprised of other fabrics or fibrous materials as well as membrane filters. In an embodiment, the filter element 30 has an average theoretical pore size for nonwoven and membrane filters, or an actual mesh size opening or average pore size for woven materials of at least 5 micrometers, preferably at least 40 micrometers, more preferably at least 80 micrometers, and most preferably at least 120 micrometers. Similarly, the mesh pore size opening may be at most 2000 micrometers, preferably at most 1000 micrometers, more preferably at most 500 micrometers, and at most preferably 200 micrometers. In one embodiment, filter element 30 consists of a single piece of element fabric without any additional filter components. The pore sizes of the filter element 30 are sufficient to retain particles, and allow the analytes contained within the liquid composition 73 to pass through.

As shown in FIGS. 4 and 5, exemplary lid 40 further comprises one or more retaining walls 35 positioned on and extending downward from inner surface 28 of lid 40. Typically, retaining walls 35 are integrally molded as a component of lid 40 (i.e., retaining walls 35 are formed during the molding process for forming lid 40). In one exemplary embodiment, as shown in FIG. 4, lid 40 comprises two or more retaining walls 35 extending along inner surface 28 of lid 40, wherein (i) each retaining wall 35 has a retaining wall length greater than a retaining wall thickness, (ii) each retaining wall 35 is positioned along an outer periphery of filter element 30, and (iii) a total length of the two or more retaining walls 35 is less than a total length of the outer periphery of filter element 30.

As shown in FIG. 4, exemplary lid 40 comprises four retaining walls 35 equally spaced from one another along outer circumference 33 of upper lid ledge 32. In an embodiment, each retaining wall 35 has a thickness ranging from 800 microns (μm) to 1200 μm, a length (i.e., in this exemplary embodiment, an arc length) extending a distance ranging from 1.0 millimeter (mm) to 22.0 mm along outer circumference 33, and a height ranging from 1.0 mm to 5.0 mm. In an embodiment, each retaining wall 35 has a segmented configuration so as to not inhibit (or minimize the effect on) fluid flow around the retaining wall 35. In some embodiments, the filter element 30 surface areas may be significantly increased by pleating and similar techniques.

Exemplary lid 40 may further comprise a lower lid ledge 26 positioned along an outer periphery of inner surface 28. Circumference 27 shown in FIG. 4 indicates the junction of lower lid ledge 26 and inner surface 28 of lid 40. Inner surface 28 of lid 40 extends upward along a conical shaped portion of lid 40. Inner surface 28 extends to inner surface 29 of cylindrical portion 24 adjacent to outer surface 22 having lid opening 91 there through.

In the proximity of the junction between inner surface 28 of lid 40 and inner surface 29 of cylindrical portion 24, and typically along inner surface 29 of cylindrical portion 24, one or more radially inwardly extending members 36 may be positioned. Like the retaining walls 35 described above, extending members 36 are typically integrally molded as a component of lid 40 as depicted in FIGS. 4 and 5. Extending members 36 may be used to attach a separate, first connected filter component 76 to lid 40 after filter element 30 has been separated from lid 40. The first connected filter component 76 of this embodiment may have a length dimension less than the distance from the top of opening 91 of cylindrical portion 24 to filter element 30.

In one embodiment shown in FIGS. 4 and 5, filter element 30 has a filter element surface area bound by an outer periphery of filter element 30, wherein the filter element surface area is greater than a smallest cross-sectional area of an opening extending from a first end of lid 40 to a second end of lid 40. In exemplary lid 40, the smallest cross-sectional area of an opening extending from a first end of lid 40 to a second end of lid 40 is the cross-sectional area of opening 91. In one exemplary embodiment, lid 40 has a conical shape, opening 91 has a circular cross-sectional configuration, and filter element 30 has a circular shape. In a further exemplary embodiment, opening 91 extends through a central portion of lid 40 from the first end to the second end of lid 40, and filter element 30 has a filter element surface area bound by an outer periphery of filter element 30, and the filter element surface area is greater than the cross-sectional area of opening 91. As described earlier, one or more filter elements 30 may be found in lid 40.

A cross-sectional view of exemplary lid 40 shown along line 3-3 of FIG. 4 is provided in FIG. 5. As shown in FIG. 4, filter element 30 is positioned a distance L_{f} from cylindrical portion 24 of lid 40. It should be understood that filter element 30 may be positioned a distance L_{f} from cylindrical portion 24, wherein L_{f} ranges from 0.0 mm to L_{c}, the total distance from cylindrical portion 24 to lower lid ledge 26 of lid 40.

Although not shown in FIGS. 4 and 5, it should be noted that lid 40 might comprise more than one attached filter elements 30. In one exemplary embodiment, lid 40 comprises a (i) filter element 30, as shown in FIGS. 4 and 5, and (ii) a second connected filter element, similar to filter element 30, attached along lower lid ledge 26 of lid 40. In this exemplary embodiment, the filter components may be similar to one another (e.g., both filter components may be filter element materials) or different from one another (e.g., a filter element material and a filter element). As an example, the filter element 30 positioned along an upper lid ledge (such as upper lid ledge 32) has a diameter of 56 mm, a element pore size of 80 micrometers, and partially surrounded by one or more retaining walls (e.g., retaining walls 35 of lid 40 in FIGS. 4 and 5), while a second filter element positioned along a lower lid ledge (such as lower lid ledge 26) has a diameter of 96 mm, an element pore size of 200 micrometers, and is surrounded by an inner wall surface of the lid 40 (e.g., lower portion 16 perpendicular to contact edge 17 of lid 40 in FIGS. 2, 4 and 5). The filter element 30 configuration may include another embodiment where the first filter element 30 has an element pore size may be of at least 5 micrometers, preferably at least 40 micrometers, more preferably at least 80 micrometers, and most preferably at least 120 micrometers. The mesh pore size opening may be of at most 2000 micrometers, preferably at most 1000 micrometers, more preferably at most 500 micrometers, and at most preferably 200 micrometers. Similarly, a second filter element 30 may have element pore sizes analogous to those of the first filter element 30 described above.

In another embodiment as shown in FIG. 2, first connected filter element 76 is supported by a stiff polymeric cylindrical frame portion 60 having an upper end that is engaged with one or more radially inwardly extending members 36 positioned along inner surface 29 of cylindrical portion 24. Examples of first connected filter elements 76 are disclosed in U.S. Pat. No. 6,536,687, the subject matter of which is incorporated herein in its entirety.

In one embodiment having multiple filter components, the lid component 11 comprises a first connected filter component 76 in lid opening 91 of FIGS. 1 and 2 further comprising a filter element 30 as depicted in FIGS. 4 and 5 attached along the inside surface 28 of lid component 11. In this embodiment, the filter element 30, and is located below the first connected filter component 76, which is attached to the inside surface 28 of lid component 11. The bottom portion of filter element 30 may be flexible, or semi-rigid. Further, filter element 30 may have any desired shape including, but not limited to, a circular shape, a square shape, a rectangular shape, a triangular shape, a pentagonal shape, a star shape, etc. In one desired embodiment, filter element 30 has a circular shape. In this embodiment, the nylon filter element 30 is connected to the polypropylene lid component 11 via an ultrasonic welding technique.

The sampling assembly 10 of the present invention may further comprise a first connected filter element 76 of lid component 11, or optional filter element 30 of lid 40. In one instance, the sampling assembly 10 may be used for mixing purposes without immediate filtration. If a user chooses to use lid component 11 with added filtration capabilities, the user may attach a first connected filter element 76 as shown in FIGS. 1-3 in lid opening 91 and/or lid sampling port 77. Optionally, a user may use lid 40 comprising filter elements 30 of the sampling assembly 10.

Further, multiple filter assemblies may be used in this invention. As described above, multiple filters can be used in a sampling assembly 10. For example, one filter in a lid component 11 or a freestanding container 12 may be used as a coarse or pre-filter, and a second filter within the same corresponding lid component 11 or freestanding container 12 with a smaller pore size placed in the direction of flow of the liquid composition 73 for removal of the sample (filtered) would further separate the debris and particulates from the liquid composition 73 for extraction. In another embodiment, a first connected filter component 76 may be nested, or contained, within a second connected filter component (not shown). As described, the second connected filter component may have a larger pore size or a similar pore size as the first connected filter component 76. As the liquid composition 73 flows through the second connected filter component, larger material or debris are removed, wherein the liquid composition 73 with smaller debris present is in fluid communication with the first connected filter component 76, which removes the remaining debris resulting in a filtered liquid composition 73 for microorganism and/or other analyte testing.

The sample preparation system of the present invention further comprises a container, such as freestanding container 12 of exemplary sampling assembly 10 as shown in FIG. 1. The container typically has at least one container sidewall 48, a free standing container bottom end 44, a free standing container top end 41 having a free standing container 12 opening therein, and an optional first set of threads 21 extending along the at least one free standing container side wall 48 as shown in FIG. 1.

As shown in FIG. 1, exemplary freestanding container 12 comprises a generally cylindrical sidewall 48 having top and bottom ends 41 and 44 extending across and closing bottom end 44 of sidewall 48, and an upper surface 15 around top end 41 of sidewall 48. Top end 41 of sidewall 48 defines an opening into freestanding container 12. Side wall 48 may bear indicia 25, for example, indicating the levels to which one or more diluents 74 or samples 72 should be sequentially poured into container 12, or optionally liner 13 to provide a predetermined ratio between one or more diluents 74, and samples 72. Desirably, container sidewall 48 is sufficiently transparent to afford seeing the liquid composition level 75 in container 12 through sidewall 48, which assists a person in adding liquids to the desired levels indicated by indicia 25. Sidewall 48 may also bear other types of indicia, such as trademarks, brand names and the like.

The freestanding container 12 may further comprise one or more additional features. In one exemplary embodiment, freestanding container 12 as shown in FIG. 1 further comprises threads 21 along an outer surface of sidewall 48 at top end 41. As discussed above, threads 21 are used to secure freestanding container 12 to other components of the sampling assemblies (e.g., lid component 11, optional liner 13, and/or collar 20). In a further exemplary embodiment, such as exemplary freestanding container 12 shown in FIG. 1, freestanding container 12 comprises a container opening 45 in bottom end 44. Container opening 45 may be used to access an optional liner 13 positioned within freestanding container 12. When present, freestanding container opening 45 typically has a circular shape and an overall diameter of 3.0 cm, although opening 45 can have any dimension and/or shape.

Free standing container 12 of sampling assembly 10 may be formed from a plastic material, for example, polyethylene or polypropylene, and may be transparent, translucent (as shown in FIG. 1) or opaque, and of any suitable size. For use with samples 72 for microbiological and/or other analyte testing, freestanding containers 12 typically have a capacity of 50 ml, 100, 250 ml, or larger.

In one exemplary embodiment, freestanding container 12 functions to contain one or more samples 72 in a diluent 74, and the freestanding container 12 further comprises a closable opening in the at least one container side wall 48 having a container sample port 78, and/or container opening 45, or both. In a further embodiment, freestanding container 12 supports a liner 13, wherein the liner is capable of containing one or more samples 72 and diluents 74.

As an alternative to the freestanding container 12 of the sampling assembly 10 as shown in FIG. 1, a first connected filter component 100 may be connected to the container sidewall 48 having a container sample port 102 as shown in FIG. 3. In a further alternate embodiment, a first connected filter component 100 may be located in container opening 45 on the container bottom end 44, which is not shown. Freestanding container opening 45 may be optionally located in another location in the container bottom end 44. The first connected filter component 100 is connected, either permanently connected or removably connected, to the container side wall 48 and/or container bottom end 44 preferably by an ultrasonic welding technique.

The sampling assembly 10 used in the method of the present invention may further comprise a liner 13. When present, the deformable liner desirably has at least one liner sidewall 13B, a liner rigid base 13A, a liner top end having a liner opening therein, and a liner rim 14 extending along and protruding from the liner top end. When used, the liner contains samples 72 and diluents 74 of liquid composition 73.

As shown in FIG. 1, exemplary liner 13 has an outer shape similar to the interior of freestanding container 12 and has a liner rim 14 at the open end, which is capable of resting on upper freestanding container surface 15. Liner 13 is freestanding or not freestanding, collapsible or not collapsible, and/or deformable upon pressure or hand gripping force, and optionally sterile or sterilizable. A freestanding liner 13 serves as a vessel for weighing and/or loading diluent 74 and/or optional samples 72. One example of a liner that is not freestanding is a plastic bag, which may change dimensions as it is loaded, and become unstable or difficult to handle during weighing, and thus locating within a freestanding container 12.

In one exemplary embodiment, liner 13 has a comparatively rigid base 13A and comparatively thin sidewalls 13B so that, when liner 13 collapses, liner 13 collapses in the longitudinal direction by virtue of the side walls collapsing rather than the base, for example when a vacuum is applied. In addition, liner 13 may optionally contain baffles, pleats, corrugations, seams, joints or gussets to control the collapse, and further reduce the volume of liner 13. Also, preferably liner 13 contains no grooves at the internal junction of the sidewalls with the base.

Further, the optional liner 13 may be collapsed under pressure or force. The liner 13 may be disposed within freestanding container 12. The freestanding container 12 may comprise a container opening 45 of container bottom end 44 and/or container sampling port 78 of sidewall 48. The ports or openings provide access to the liner 13 within the container. Hand pressure or force may be applied to the liner to force out the liquid composition 73 through the filter element 30 of lid 40 or through first connected filter component 76 of lid component 11.

In another embodiment, liner 13 may contain a pre-measured quantity of a diluent 74 with a sealed lid (not shown), which is removable, for ease of handling and reduction of contamination. The liner 13 may optionally comprise a powder or dry composition with a sealed lid, which is removable.

In a further embodiment, several optional new liners 13 are inserted into several freestanding containers 12 to provide for a plurality of samples 72 and diluents 74 in sampling assemblies 10. The sampling assemblies 10 contents comprising liquid compositions 73, may be agitated for a period of time, and filtered samples of the liquid compositions 73 may be recovered for microorganism and/or other analyte testing.

Typically, liner 13 comprises a polymeric material, such as a polyolefin, including but not limited to polypropylene, polyethylene, and poly(methylpentene). The liner 13 is formed from a molding process such as a thermoforming process. In one embodiment of the present invention, liner 13 comprises thermoformed low-density polyethylene.

For certain applications, liner 13 may be required to collapse under a pressure differential. In this case, the liner sidewall 13B is preferentially thinner than the liner rigid base 13A. For example, with low-density polyethylene liners 13, the thickness of the liner sidewalls 13B are at least 50 micrometers, preferably at least 100 micrometers, more preferably at least 150 micrometers, and most preferably at least 200 micrometers. The thickness of the liner rigid base 13A is at least 225 micrometers, preferably at least 275 micrometers, more preferably at least 300 micrometers, and most preferably at least 350 micrometers. These dimensions may be dependent on the composition of the liner 13. Further, these dimensions are not limited specifically to this embodiment, and will be become apparent to those skilled in the art.

In one embodiment of the present invention, the sample preparation system comprises a sampling assembly 10 having a disposable liner 13 in combination with a freestanding container 12 described above. In this embodiment, a sample 72 is in a sterile diluent 74, and comes into contact with the inner walls of liner 13. During agitation of the sample 72, mixing occurs to suspend, dissolve, or disperse the microorganisms and/or other analytes in the diluent 74 of the liquid composition 73.

Further, freestanding container 12 may be a reusable and/or optionally sterilizable container. With a reusable freestanding container 12, the liner 13 may be disposable. In order to reuse freestanding container 12, a new liner 13 is disposed within.

In a further embodiment, the sample 72 and diluent 74 are in fluid communication with the first connected filter component 76 located in the lid component 11 either during agitation, or when decanting or by other means to remove the liquid composition 73 from the sampling assembly 10. A sample of the filtered liquid composition 73 may be removed via lid opening 91, and subsequently analyzed for microorganisms and/or other analytes.

In another embodiment, freestanding container 12 may comprise an optional opening in the container bottom end 44 (e.g., opening 45 shown in FIG. 1) and/or container sidewall 48 having container sampling port 78. The openings or ports of freestanding container 12 may be used to connect a first connected filter component 100 as shown in FIG. 3, or be used as a sampling port. Optionally, a sample of the filtered liquid composition 73 may be further removed through lid 92 comprising a first connected filter component 104 at lid opening 91 and/or lid sampling port 102.

The sampling assemblies 10 for microbiological testing of the present invention may further comprise an optional collar 20. When present, the collar 20, in an embodiment, has a top end having a collar opening therein, a bottom end, and at least one collar side wall extending between the top end and the bottom end, a collar rim 18 extending along the top end and protruding into the collar opening, and an optional second set of threads 19 extending along the at least one collar side wall, wherein the second set of threads is capable of engaging with a first set of threads on the freestanding container 12.

As shown in FIG. 1 and as discussed above, collar 20 comprises upper rim 18 and collar threads 19 positioned on an inner surface of collar 20. Upper rim 18 and collar threads 19 work along with container threads 21 to secure lid component 11 and optional liner 13 disposed in a freestanding container 12 of a sampling assembly 10. Optional threads 21 may be replaced by other means to secure lid component 11 to freestanding container 12 with optional liner 13. By providing lid component 11 with threads, the lid component 11 may be screwed directly onto the freestanding container 12.

Collar 20 may be a molded plastic component, or may be a machined metal (for example, aluminum) component. In a further embodiment, collar 20 is a molded plastic component comprising glass fiber reinforced polypropylene.

As an alternative to using collar 20 for securing lid component 11 to free standing container 12, other means include clamping, friction fitting, snap engagement fitting, and other means known in the art.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

### EXAMPLES

All solvents and reagents were obtained from Aldrich Chemical Company, Milwaukee, Wis., unless otherwise noted. All percents and amounts are by weight unless otherwise specified. 3M™ Company Paint Preparation System liners (part number 16114) and freestanding containers (part number 16115) and associated lids and collars were supplied by 3M Company of St. Paul, Minn. The shaker used was Burrell model 75-wrist action shaker supplied by Burrell Scientific Company of Pittsburgh, Pa. Sterile diluent (Butterfield's buffer) was purchased from Edge Biological of Memphis, Tenn. The vortexer was a model VX-2500 Multi-Tube Vortexer from VWR Scientific Products of West Chester, Pa. Aerobic count was determined using 3M™ Petrifilm™ Aerobic Count Plates and Plate Readers were obtained from 3M Company of St. Paul, Minn.

Ground beef and pork (estimated to contain 25% fat) samples were purchased from local grocery stores. Portions (150 grams) were separated, placed in plastic bags, and stored in a freezer at −20° C. Spinach leaves were also purchased from local grocery stores, and stored at 4° C. in their original containers. Prior to use, required portions of ground beef and pork were removed from the freezer, kept for approximately 2 hours at room temperature to thaw the samples, followed by thorough mixing in the bag using a wooden spatula before use. Spinach samples were tested immediately after removal from the 4° C. storage.

### Comparative Example 1 (C1)

This example demonstrates quantification of microbial and/or other analytes release from a ground beef sample using the Stomacher procedure. A portion of ground beef (11 g) was placed in a Stomacher bag (Seward model 400 from Seward, Inc. of Norfolk, UK), and after addition of Butterfield's buffer (99 ml), the bag was placed in a Stomacher (Seward Model 400, from Seward, Inc., of Norfolk, UK). The liquid composition was stomached at 230 rpm for the designated times as reported in Table 1. After each time interval, 2 ml of the filtered liquid composition was collected for analysis by pipette transfer to a sterile test tube. A portion of the filtered liquid compositions collected (500 microliters) was diluted with Butterfield's Buffer (99 ml), and shaken manually for approximately 10 seconds after which an aerobic count for each filtered liquid composition was determined and reported in Table 1.

### Comparative Example 2 (C2)

This example demonstrates quantification of microbial and/or other analytes release from a ground pork sample using the Stomacher procedure. A portion of ground pork (11 g) was placed in a Stomacher bag (Seward model 400 from Seward, Inc. of Norfolk, UK), and after addition of Butterfield's buffer (99 ml), the bag was placed in a Stomacher (Seward Model 400, from Seward, Inc., of Norfolk, UK). The liquid composition was stomached at 230 rpm for the designated times as reported in Table 1. After each time interval, 2 ml of the filtered liquid composition was collected for analysis by pipette transfer to a sterile test tube. A portion of the filtered liquid compositions collected (1000 microliters) was diluted with Butterfield's Buffer (9 ml), and shaken manually for approximately 10 seconds after which an aerobic count for each filtered liquid composition was determined and reported in Table 1.

### Comparative Example 3 (C3)

This example demonstrates quantification of microbial release and/or other analytes from spinach leaves using the Stomacher procedure. A portion of spinach leaves (11 g) was placed in a Stomacher bag (Seward model 400 from Seward, Inc. of Norfolk, UK), and after addition of Butterfield's buffer (99 ml), the bag was placed in a Stomacher (Seward Model 400, from Seward, Inc., of Norfolk, UK). The liquid composition was stomached at 230 rpm for the designated times as reported in Table 1. After each time interval, a 2 ml of the filtered liquid composition was collected for analysis by pipetter transfer to a sterile test tube. A portion of the filtered liquid compositions collected (1000 microliters) was serially diluted with Butterfield's Buffer to a final concentration of 1:20,000, after which an aerobic count for each filtered liquid composition was determined and reported in Table 1.

### Example 1 (E1)

This example demonstrates quantification of microbial and/or other analytes release from a ground beef sample using mechanical shaking. An empty liner was placed on a balance and ground beef (11 g) was transferred into the liner. The liner was then removed from the balance and placed in a freestanding container. Sterile diluent (99 ml) was added to the liner containing the ground beef sample, and a lid containing a first connected filter component was placed on the sampling assembly. This assembly was then secured using the threaded collar. The opening in the lid was sealed with the closure. The assembly containing ground beef and diluent was placed in a clamp secured to the arm of the shaker. The distance from the center of the assembly to the rod on the shaker was approximately 20 cm. The sample was shaken for 15 seconds at an equipment dial setting of 10, corresponding to a frequency of approximately 6 cycles per second at an approximate arc of 17 degrees. After this time period, with the closure removed, approximately 2 ml of the liquid composition was decanted through the first connected filter component in the lid component into a sterile test tube. The sampling assembly was capped, returned to the shaking device, and agitated for additional time periods as required. The mixing/decanting cycle was repeated as described, and liquid compositions were collected at 60, 120, and 240 seconds time points. A portion of filtered liquid compositions collected (500 microliters) was diluted with Butterfield's Buffer (99 ml), and shaken manually for approximately 10 seconds after which an aerobic count for each filtered liquid composition was determined and reported in Table 1.

### Example 2 (E2)

This example demonstrates quantification of microbial and/or other analytes release from a ground beef sample using a vortex mixer. An empty liner was placed on a balance and ground beef (11 g) was transferred into the liner. The liner was then removed from the balance and placed in a freestanding container. Sterile diluent (99 ml) was added to the liner containing the ground beef sample and a lid containing a first connected filter component was placed on the sampling assembly. This assembly was then secured using the threaded collar. The opening in the lid was sealed with the closure provided. The assembly containing ground beef and diluent was placed and secured on the platform of the Vortexer with an eccentric orbit (approximately 6 mm×4 mm). The liquid composition was mixed for 15 seconds at an equipment dial setting of 10, corresponding to rotation speed of approximately 2500 rpm. After this time period, the closure was removed and approximately 2 ml of the liquid composition was decanted through the first connected filter component in the lid into a sterile test tube. The freestanding container of the sampling assembly was closed using the closure, returned to the vortexing device, and mixed for additional time periods as required. The mixing/decanting cycle was repeated as described and liquid compositions were collected at 60, 120, and 240 seconds time points. A portion of the filtered liquid compositions collected (500 microliters) was diluted with Butterfield's Buffer (99 ml) and shaken manually for approximately 10 seconds after which an aerobic count for each filtered liquid composition was determined and reported in Table 1.

### Example 3 (E3)

This example demonstrates quantification of microbial release and/or other analytes from a ground pork sample using a vortex mixer. An empty liner was placed on a balance and ground beef (11 g) was transferred into the liner. The liner was then removed from the balance and placed in a freestanding container. Sterile diluent (99 ml) was added to the liner containing the ground pork sample and a lid containing a first connected filter component was placed on the sampling assembly. This assembly was then secured using the threaded collar. The opening in the lid was sealed with the closure provided. The assembly containing ground pork and diluent was placed, and secured on the platform of the Vortexer with an eccentric orbit (approximately 6 mm×4 mm). The liquid composition was mixed for 15 seconds at an equipment dial setting of 10, corresponding to a rotation speed of approximately 2500 rpm. After this time period, the closure was removed and approximately 2 ml of diluent was decanted through the first connected filter component in the lid into a sterile test tube. The freestanding containers of the sampling assembly was closed with a closure, returned to the vortexing device, and mixed for additional time periods as required. The mixing/decanting cycle was repeated as described and liquid compositions were collected at 60, 120, and 240 seconds time points. A portion of the filtered liquid compositions collected (1000 microliters) was diluted with Butterfield's Buffer and shaken manually for approximately 10 seconds after which an aerobic count for each filtered liquid composition was determined and reported in Table 1.

### Example 4 (E4)

This example demonstrates quantification of microbial and/or other analytes release from spinach leaf samples using a mechanical shaker. An empty liner was placed on a balance and spinach leaf (11 g) was transferred into the liner. The liner was then removed from the balance and placed in a freestanding container. Sterile diluent (99 ml) was added to the liner containing the spinach leaf sample, and a lid containing a first connected filter component was placed on the sampling assembly. This assembly was then secured using the threaded collar. The opening in the lid was sealed with the closure provided. The assembly containing spinach leaf and diluent was placed in a clamp secured to the arm of the shaker. The distance from the center of the assembly to the rod on the shaker was approximately 20 cm. The liquid composition was shaken for 15 seconds at an equipment dial setting of 10, corresponding to a frequency of approximately 6 cycles per second at an approximate arc of 17 degrees. After this time period, with the closure removed, approximately 2 milliliters of liquid composition was decanted through the first connected filter component in the lid into a sterile test tube. The freestanding container of the sampling assembly was closed with a closure, returned to the shaking device, and agitated for additional time periods as required. The mixing/decanting cycle was repeated as described and filtered liquid compositions were collected at 60, 120, and 240 seconds time points. A portion of the filtered liquid compositions collected (1000 microliters) was serially diluted with Butterfield's Buffer to a final concentration of 1:20,000 after which an aerobic count for each filtered liquid composition was determined and reported in Table 1.

### Example 5 (E5)

This example demonstrates quantification of microbial and/or other analytes release from spinach leaf samples using a vortex mixer. An empty liner was placed on a balance and spinach leaf (11 g) was transferred into the liner. The liner was then removed from the balance and placed in a freestanding container. Sterile diluent (99 ml) was added to the liner containing the spinach leaf sample, and a lid component containing a first connected filter component was placed on the sampling assembly. This assembly was then secured using the threaded collar. The opening in the lid was sealed with the closure provided. The sampling assembly containing spinach leaf and diluent was placed and secured on the platform of the Vortexer with an eccentric orbit (approximately 6 mm×4 mm). The sample was mixed for 15 seconds at an equipment dial setting of 10, corresponding to rotation speed of approximately 2500 rpm. After this time period, with the closure removed, approximately 2 ml of the liquid composition was decanted through the first connected filter component in the lid into a sterile test tube. The freestanding container of the sampling assembly was closed with a closure, returned to the vortexing device, and mixed for additional time periods as required. The mixing/decanting cycle was repeated as described and filtered liquid compositions were collected at 60, 120, and 240 seconds time points. A portion of filtered liquid compositions collected (1000 microliters) was serially diluted with Butterfield's Buffer to a final concentration of 1:20,000, after which an aerobic count for each filtered liquid composition was determined and reported in Table 1.

Table 1 contains aerobic count data for filtered liquid compositions taken at each of the times (in seconds) below using different techniques to release microorganisms and/or other analytes from the sample.

TABLE 1

| | | | | Time | Time | Time | Time |
|---|---|---|---|---|---|---|---|
| Sample No. | Sample | Technique | Time 15 sec. | 30 sec. | 60 sec. | 120 sec. | 240 sec. |
| C1 | Ground | Stomacher | 16 | 168 | 171 | 172 | 127 |
| | Beef | | | | | | |
| C2 | Ground | Stomacher | 21 | 147 | 161 | 173 | 168 |
| | Pork | | | | | | |
| C3 | Spinach | Stomacher | 13 | 216 | 238 | 247 | 223 |
| | Leaves | | | | | | |
| E1 | Ground | Mechanical | 14 | 192 | 205 | 191 | 155 |
| | Beef | Shaker | | | | | |
| E2 | Ground | Vortex | 32 | 155 | 187 | 150 | 154 |
| | Beef | Mixer | | | | | |
| E3 | Ground | Vortex | 02 | 131 | 157 | 197 | 181 |
| | Pork | Mixer | | | | | |
| E4 | Spinach | Mechanical | 28 | 375 | 335 | 280 | 249 |
| | Leaves | Shaker | | | | | |
| E5 | Spinach | Vortex | 26 | 25 | 302 | 339 | 267 |
| | Leaves | Mixer | | | | | |

The results of Table 1 show that the microbial and/or other analytes recovery is comparable to the stomaching device. Preparation of the liquid compositions was greatly facilitated by the use of the sampling assemblies of the present invention as demonstrated by mechanical shaking and vortex mixing.

What is claimed is:

1 A method of preparing samples for analyte testing comprising:
a) combining a sample and a diluent to produce a liquid composition in a sampling assembly comprising
a lid component,
and a freestanding container having a first connected filter component, wherein the filter component is connected to either the lid component or the sidewall of the freestanding container;
b) agitating the liquid composition; and
c) removing a filtered liquid composition.

2. The method of claim 1, wherein the sampling assembly further comprises a second connected filter component.

3. The method of claim 1, wherein the filtered liquid composition contains at least one analyte.

4. The method of claim 1, wherein the analyte comprises biological compounds, viruses, toxins, proteins, fungus, protozoa, prion, allergens and nucleic acids.

5. The method of claim 1, wherein the analyte comprises biological toxins, and toxic metabolites.

6. The method of claim 1, wherein the analyte comprises spores and vegetative bacteria.

7. The method of claim 4, wherein the viruses comprise a DNA virus, or a RNA virus.

8. The method of claim 4, wherein the viruses are enveloped or non-enveloped.

9. The method of claim 4, wherein the fungus comprises yeast.

10. The method of claim 4, wherein the allergens comprise pollens, dust mites, molds, danders, and proteins.

11. The method of claim 4, wherein the nucleic acids comprise DNA and RNA.

12. The method of claim 1, wherein the sample comprises a food sample.

13. The method of claim 12, wherein the food sample comprises meat, beverages, poultry, fish, eggs, fruits, vegetables, dairy products, grain products, and prepared food products.

14. The method of claim 13, wherein the food sample is a solid, liquid or a combination thereof.

15. The method of claim 1, wherein the sample comprises a nonfood sample.

16. The method of claim 1, wherein the first connected filter component is collapsible.

17. The method of claim 1, wherein the first connected filter component is rigid.

18. The method of claim 1, wherein the first connected filter component is connected to the freestanding container.

19. The method of claim 1, wherein the first connected filter component is connected to the lid component.

20. The method of claim 1, wherein the first connected filter component has a shape that encloses a volume of the diluent, and the filtered liquid composition is removed from within the volume of the first connected filter component.

21. The method of claim 1, wherein the sample is contained within a volume of the first connected filter component, and the filtered liquid composition is removed from within the volume of the freestanding container.

22. The method of claim 1, wherein the lid component comprises a sampling port.

23. The method of claim 1, wherein the freestanding container comprises a sampling port.

24. The method of claim 1, wherein the lid component is hermetically sealed to the freestanding container.

25. The method of claim 1, wherein a liner is contained within the freestanding container.

26. The method of claim 25, where the liner is freestanding.

27. The method of claim 25 wherein the lid component is hermetically sealed to the liner.

28. The method of claim 1 comprising a plurality of the sampling assemblies each of which contains a liquid composition.

29. The method of claim 1, wherein the liquid composition is incubated for a period of time prior to removal from the sampling assembly.

30. An article comprising a sampling assembly having a freestanding container, a first connected filter component, and a lid component, wherein the sampling assembly contains a diluent and an optional sample.

31. The article of claim 30, wherein the sampling assembly further comprises a second connected filter component.

32. The article of claim 30, wherein a liner is contained within the freestanding container.

33. The article of claim 30, wherein the sampling assembly contains a nutrient formulation.
